(19) United States
(12) Patent Application Publication
(10) Pub. No.: US 2007/0109591 A1
(43) Pub. Date: May 17, 2007

(54) Mobile-communication device directed printing

(76) Inventors: Samuel Nathan Kamens, Highland Park, NJ (US); Daniel G. Owens, Marietta, GA (US); David Guthrie, Atlanta, GA (US); Naveen S. Saxena, Cupertino, CA (US); J. Scott Tapp, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/273,073

(22) Filed: Nov. 14, 2005

(51) Int. Cl. G06F 3/12

(52) U.S. Cl. 358/1.15

(57) ABSTRACT

A method for providing a remote print capability comprises receiving information from a communication device, the information comprising document and destination identifiers, confirming the communication device belongs to a registered user, identifying a document type from the information, retrieving a document responsive to the document identifier, converting the document from a native format to an image file format and transmitting the image file format representation of the document to a destination responsive to the destination identifier. A system comprises a processor, interfaces in communication with the public-telephone network and a data network and a memory. The system receives information from a mobile device and transmits an image file format representation of a document to a facsimile device in response to the information. The system can be used in cooperation with a mobile-telephone service and associated online tools for reporting, accounting, and interacting with subscribers.

### BACKGROUND

Portable devices that link users to communication services are popular and widespread. Mobile-communication devices are commercially available with more and more functionality that until recently has been provided by computing devices interconnected using wired communication links. For example, cellular telephone service providers now provide email services, paging, instant messaging, internet access and a host of other information services.

A user of a mobile-communication device can download a web page or access other information by locating an associated file stored on a device connected to the internet. Some conventional devices allow an operator to initiate a print job to create a hard copy of content stored on the device or accessible via the Internet. For example, existing personal-digital assistants (PDAs) generally transfer content and commands from the PDA to a local printer using a wireless link. However, methods for enabling mobile devices to print a file are problematic.

Limited storage space on the mobile-communication device hinders the ability of the device to efficiently communicate data-rich content from the device to a designated printer. Typically, in order to print out a document, it is necessary for an originating device, such as a personal computer, laptop computer, PDA, etc., to have a printer device driver loaded prior to being able to print. The printer device driver provides an abstracted interface between the operating system (OS) and a specific printer to enable the OS and applications running on the OS to communicate with any printer supported by the OS using a common set of text, graphic, and layout commands. This enables developers to create applications without having to be concerned with the specific operations of the various printers that may be used with the application. These printer specific operations are handled by the OS in combination with the printer device drivers.

In today's mobile society, people often encounter situations in which they are away from their home office, yet need to be able to print documents, files, or other content at either a nearby printer or a select printer proximate to a business contact that they wish to provide a hard copy of the document. Generally, to use a printer to generate a copy of the desired file or content, two things need to happen. First, a device on which the document files are stored (or through which they may be accessed) must be communicatively linked with the destination printer. This can be accomplished indirectly by connecting to a network to which the printer may be accessible, or by directly connecting to the printer via a wireless transceiver, e.g., an IEEE 802.11a compatible transceiver, a Bluetooth transceiver, or a printer cable such as a serial, parallel, or USB cable.

In many cases, both of the direct connection solutions may be impractical or unavailable. For example, many business printers are designed to be connected to a local area network. Many of these shared network printers are not configured with a wireless interface. Additionally, a business guest often does not have the authority or the desire to interrupt a network connection to a business host's shared network printer to connect their device to the network printer. Moreover, many security conscious network administrators would not allow a “foreign” computing device to be coupled to their network to enable indirect communications to a shared network printer.

Assuming that a mobile device operator has successfully established a connection with a desired printer, the operator still must identify an appropriate printer driver. As discussed above, in order for the mobile device to be able to print via a printer, an appropriate printer device driver must be loaded on the mobile device. In general, a specific device driver will be required for each unique type of printer and in some cases unique models within a similar line of printers. These drivers take time to identify and load. In addition, printer device drivers occupy storage space and can cause software conflicts with applications on the mobile device. Invariably, the business traveler will not have easy access or be able to identify the needed driver.

Consequently, improved ways are needed to generate a hard copy of a document using a mobile-communication device.

### SUMMARY

An embodiment of a method for providing a remote print capability comprises receiving information from a communication device, the information comprising document and destination identifiers, confirming the communication device belongs to a registered user, identifying a document type from the information, retrieving a document responsive to the document identifier, converting the document from a native format to an image file format and transmitting the image file format representation of the document to a destination responsive to the destination identifier.

An alternative method for providing a remote print capability comprises providing executable instructions on a mobile-communication device, such that when executed by the mobile-communication device, the device prompts an operator of the mobile-communication device to identify a document and a destination and transmits an electronic mail message to a server coupled to a wireless network and the public telephone network, the electronic mail message configured to direct the server to confirm the mobile-communication device belongs to a subscriber, retrieve a document, convert the document to an image file format and transmit the document in the image file format to the destination along the public telephone network.

Related systems are also invented and disclosed. An embodiment of a system comprises a processor, a first interface in communication with a public-telephone network, a second interface in communication with a data network and a memory. The memory comprises executable instructions that when executed by the processor direct the system to receive information via the second interface from a mobile-communication device, the information comprising a document identifier and a destination identifier, convert a document responsive to the document identifier from a native file format to an image file format representation of the document and transmit the image file format representation of the document via the first interface to a destination responsive to the destination identifier.

Other systems, methods, features and advantages will be or will become apparent to one with skill in the art upon examination of the following figures and detailed description. All such additional systems, methods, features and advantages are defined by the accompanying claims.

### BRIEF DESCRIPTION OF THE FIGURES

The systems and methods for mobile-communication device directed printing can be better understood with reference to the following figures. The functions within the various figures are not necessarily performed in the order presented, emphasis instead being placed upon clearly illustrating the principles used to enable a mobile-communication device user to print a document at a designated facsimile device.

Moreover, in the figures, like reference numerals designate corresponding parts throughout the different views.

FIG. 1 is a schematic diagram illustrating a communication system.

FIG. 2 is a block diagram illustrating an embodiment of the fax server of FIG. 1.

FIG. 3 is a block diagram illustrating an embodiment of the mobile-network bridge of FIG. 1.

FIGS. 4A and 4B are schematic diagrams illustrating embodiments of graphical-user interfaces on the mobile device of FIG. 1.

FIGS. 5A and 5B are schematic diagrams illustrating alternative embodiments of graphical-user interfaces on the mobile-communication device of FIG. 1.

FIGS. 6A and 6B are schematic diagrams illustrating other embodiments of graphical-user interfaces on the mobile-communication device of FIG. 1.

FIG. 7 is a flow diagram illustrating an embodiment of a method for providing a remote print capability.

FIG. 8 is a flow diagram illustrating an embodiment of a alternative method for providing a remote print capability.

### DETAILED DESCRIPTION

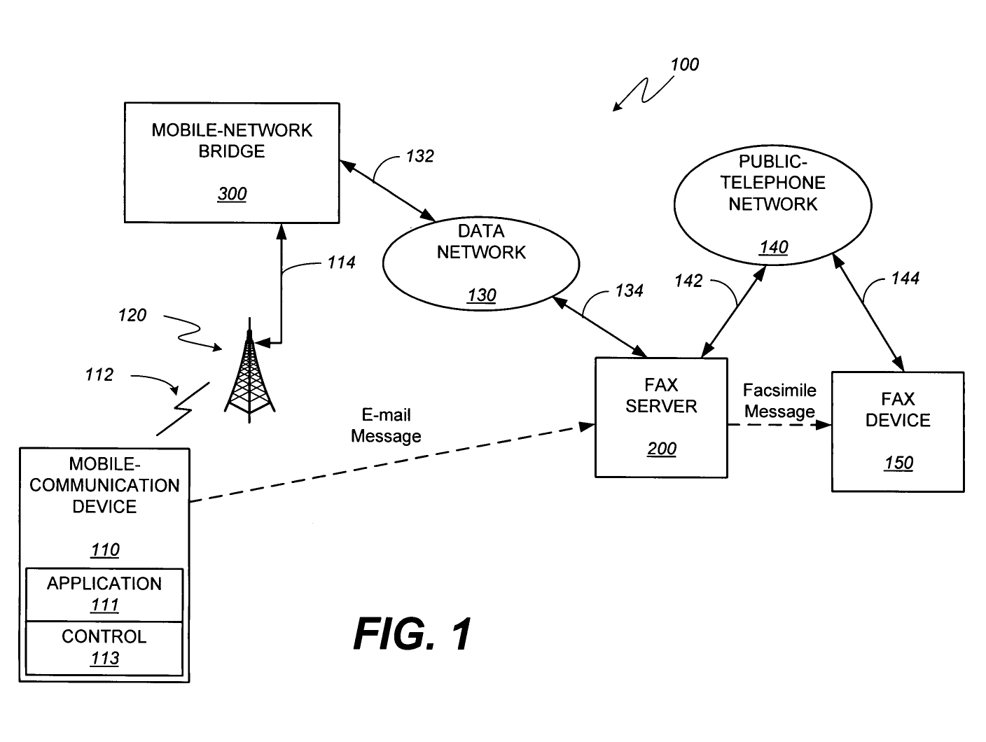

Various embodiments of systems and methods for mobile-communication device directed printing to a select facsimile device will be described with respect to FIGS. 1-8. A mobile “print to a fax” service includes one or more mechanisms for a present subscriber of mobile communication services (i.e., voice and data) to subscribe to the additional level of service. For example, a customer may complete basic account and service information via a website arranged to collect such information and interact with a service provider's back-office systems. Back-office systems include accounting, billing and management functions.

Once a subscriber has subscribed to the service, a Java application is sent to the customer's mobile-communication device to enable the service. The application includes logic for integrating various input/output controls available on the device with one or more menus and options that enable an operator to identify one or more attachments to be printed by a select fax device. The application generates an e-mail message addressed to a fax server. The e-mail message includes information that directs the fax server to process the subscriber's request. One or more of the customer's name, e-mail address, or a phone number associated with the customer's mobile-communication device are used by the fax server to authenticate the subscriber before processing received requests. The received e-mail message includes information identifying one or more files desired to be printed and a destination facsimile device number.

In addition to the website arranged to collect information to enroll subscribers, a service provider provides one or more reporting websites that enable a subscriber of the service to retrieve and present usage history, troubleshoot, resend documents, configure account information, etc.

Having described the general operation of various embodiments for mobile-communication device directed printing to a select facsimile device; various additional embodiments will be described with respect to FIGS. 1-8. FIG. 1 is a schematic diagram illustrating a communication system 100. As illustrated in FIG. 1, communication system 100 comprises a mobile-communication device 110 in indirect communication with fax device 150 via multiple networks. Mobile-communication device 110 is in communication with mobile network 120 via radio-frequency link 112 and includes application 111 and control interface 113. Application 111 comprises executable instructions configured to direct an external fax server in communication with the mobile-communication device to complete a series of asks to direct a remote facsimile device to produce a hard copy of a select document. Application 111 interfaces with and responds to one or more operator inputs via control interface 113. Control interface 113 may be specific to a mobile device type and can be integrated with both dedicated mechanisms and multi-function mechanisms for entering text, navigating graphical-user interfaces, selecting options, and otherwise interfacing with the mobile-communication device 110.

Mobile network 120 can be any available network that supports the use of a portable communication device with data and voice communication features. Mobile network 120 is in communication with mobile-network bridge 300 via communication link 114. Mobile-network bridge 300 is in communication with fax server 200 via communication link 132, data network 130 and communication link 134. Mobile-network bridge 300 enables mobile network 120 to communicate with devices coupled to data network 130. Fax server 200, which is coupled to data network 130 via communication link 134 is also in communication with the public-telephone network 140 via communication link 142. Public-telephone network 140 includes any number of local exchange carrier central offices, access tandems, long-distance facilities, and other telecommunication switching systems. Fax server 200, in turn, communicates with fax device 150 via communication link 144. Fax device 150 is any device capable of converting information received in an image file format communicated over communication link 144 from PTN 140 into a hard copy. Communication links 114, 132, 134, 142 and 144 may be wired or wireless. In preferred embodiments, communication links 112, 114, 132, 134 and 142 are digital links. One or more portions of communication link 144 may comprise analog links.

As indicated in FIG. 1, an e-mail message is generated and transmitted from mobile-communication device 110 and traverses mobile network 120 and data network 130 on its way to fax server 200. Fax server 200 receives the e-mail message and generates a facsimile format representation and forwards the same via public-telephone network 140 to a destination fax device 150. The information identified in the e-mail message and the destination fax device is identified in the e-mail message sent from the mobile-communication device 110. Mobile-communication device 110 includes a Java application that exposes and uses the operator interfaces on the device to enable an operator of the device to generate an e-mail message that directs fax server 200.

In an alternative embodiment, facsimile format representations are communicated to fax device 150 via data network 130 or other proprietary data networks (not shown). When fax device 150 is coupled to a data network, facsimile format messages are sent via user data protocol (UDP) or transmission control protocol/Internet protocol (TCP/IP) packets. This can be accomplished using the T.38 international telecommunication union (ITU) standard. The T.38 standard describes the technical features that enable the transfer of documents in real-time between standard Group 3 facsimile terminals over the Internet or other data networks using Internet protocols. The T.38 standard is an aggregation of earlier versions of the standard and subsequent amendments that include and describe session initiation protocol (SIP) procedures.

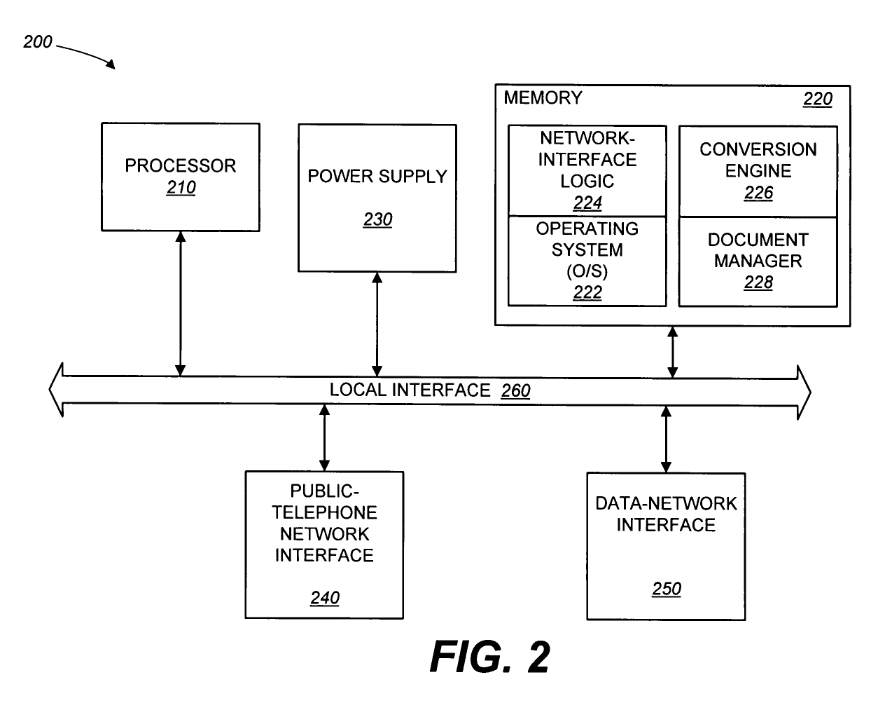

FIG. 2 is a block diagram illustrating an embodiment of the fax server 200 of FIG. 1. Generally, in terms of hardware architecture, as shown in FIG. 2, fax server 200 includes processor 210, memory 220, power supply 230, public-telephone network (PTN) interface 240 and data-network interface 250. Processor 210, memory 220, PTN interface 240 and data-network interface 250 are communicatively coupled via a local interface 260. The local interface 260 can be, for example but not limited to, one or more buses or other wired or wireless connections, as is known in the art. The local interface 260 may have additional elements, which are omitted for simplicity, such as controllers, buffers (caches), drivers, repeaters, and receivers, to enable communications. Further, the local interface 260 may include address, control, and/or data connections to enable appropriate communications among the aforementioned components.

Power supply 230 provides power to each of the processor 210, memory 220, PTN interface 240, data-network interface 250 and local interface 260 in a manner understood by one of ordinary skill in the art.

Processor 210 is a hardware device for executing software, particularly that stored in memory 220. The processor 210 can be any custom made or commercially available processor, a central processing unit (CPU), an auxiliary processor among several processors associated with the fax server 200, a semiconductor based microprocessor (in the form of a microchip or chip set), or generally any device for executing software instructions.

The memory 220 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 220 may incorporate electronic, magnetic, optical, and/or other types of storage media. Note that the memory 220 can have a distributed architecture, where various components are situated remote from one another, but can be accessed by the processor 210.

The software in memory 210 may include one or more separate programs, each of which comprises an ordered listing of executable instructions for implementing logical functions. In the example of FIG. 2, the software in the memory 220 includes operating system 222, network-interface logic 224, conversion engine 226 and document manager 228. The operating system 222 essentially controls the execution of other computer programs, such as network-interface logic 224, conversion engine 226 and document manager 228 and provides scheduling, input-output control, file and data management, memory management, and communication control and related services.

Network-interface logic 224 comprises one or more programs and one or more data elements that enable each of the conversion engine 226 and the document manager 228 to communicate with external devices via PTN interface 240 and data-network interface 250. In this regard, network-interface logic 224 may include one or buffers and parameter stores for holding configuration information and or data as may be required. Conversion engine 226 comprises one or more programs and one or more data elements that enable the fax server 200 to translate a document in a native format to an image file format. A native format is identified via a file extension attached to a filename. Conversion engine 226 is equipped to convert documents in popular file formats such as but not limited to .doc, .pdf., .xls, .rtf, etc. into one or more image file formats compatible with facsimile devices. Facsimile devices are generally configured to receive and generate a hard copy of a document encoded by one or more standards. The comite consultafif international de telegraphique et telephonique (International Telegraph and Telephone Consultative Committee or CCITT—now the ITU-T) Fax Group 3 (G3) encoding format, specified in CCITT Recommendation T.4, is perhaps the most commonly used today due to the ubiquity of G3 facsimile machines in the office environment. It supports one-dimensional image compression (compression within the line only) of black and white images. The 1-dimensional compression scheme uses run-length and Huffinan encoding and can achieve compression ratios of 10:1 for office documents and 15:1 for engineering drawings. The resolution of G3-encoded images is 200 dpi. Group 3 is used on standard speed fax machines connected to the public-telephone network. It was designed to operate at one minute or less per page; use digital techniques to enhance speed including redundancy reduction and bandwidth compression, and for machines including a 9600 bits/second modem (CCITT V.29) to permit timely transmission of document pages. Document manager 228 comprises one or more programs and one or more data elements that enable the fax server 200 to receive electronic versions of documents, temporarily store, and transmit converted documents via PTN interface 240. Document manager 228 is also configured to authenticate subscribers and perform accounting tasks.

Network-interface logic 224, conversion engine 226 and document manager 228 are source programs, executable programs (object code), scripts, or any other entities comprising a set of instructions to be performed. When implemented as source programs, the programs are translated via a compiler, assembler, interpreter, or the like, which may or may not be included within the memory 220, so as to operate properly in connection with the O/S 222. Furthermore, network-interface logic 224, conversion engine 226 and document manager 228 can be written in one or more object-oriented programming languages, which have classes of data and methods, or procedure programming languages, which have routines, subroutines, and/or functions. In the currently contemplated best mode, network-interface logic 224, conversion engine 226 and document manager 228 are implemented in software, as executable programs executed by processor 210.

PTN interface 240 enables fax server 200 to communicate with various devices over the public-telephone network 140 (FIG. 1) via connection 205. The PTN interface 240 performs a variety of functions including, for example: answering a phone line; hanging-up a phone line; dialing a phone number; sending fax data; receiving fax data; sending data signals; receiving data signals; generating dual tone multi-frequency (DTMF) tones; detecting DTMF tones; receiving automatic number identification—the number from which a caller initiates a call (ANI) and dialed number identification service—the number dialed by the caller (DNIS) playing voice messages; and converting voice signals between analog and digital formats.

Data-network interface device 250 enables fax server 200 to communicate with various devices over the data network 130 (FIG. 1) via connection 134. The data-network interface device 250 performs the signal conditioning and format conversions to communicate data through the data network 130. An example data-network interface device 250 is compatible with the 100Base T Ethernet standard and the TCP/IP protocol. It should be understood that other data-network interfaces including, for example and without limitation, wired and wireless data-network interfaces, analog-data network interfaces, digital-data network interfaces, optical-data network interfaces, and data-network interfaces compatible with other hardware and software standards and protocols may also be used.

When fax server 200 is in operation, the processor 210 is configured to execute software stored within the memory 220, to communicate data to and from the memory 220, and to generally control operations of the fax server 200 pursuant to the software. The network-interface logic 224, conversion engine 226, document manager 228 and the O/S 222, in whole or in part, but typically the latter, are read by the processor 210, perhaps buffered within the processor 210, and then executed.

When the network-interface logic 224, conversion engine 226 and document manager 228 are implemented in software, as is shown in FIG. 2, it should be noted that these software elements can be stored on any computer-readable medium for use by or in connection with any computer related system or method. In the context of this document, a “computer-readable medium” is an electronic, magnetic, optical, or other physical device or means that can contain or store a computer program for use by or in connection with a computer related system or method. The network-interface logic 224, conversion engine 226 and document manager 228 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where one or more of the network-interface logic 224, conversion engine 226 and document manager 228 are implemented in hardware, the network-interface logic 224, conversion engine 226 and document manager 228 can implemented with any or a combination of the following technologies, which are each well known in the art: a discrete logic circuit(s) having logic gates for implementing logic functions upon data signals, an application-specific integrated circuit (ASIC) having appropriate combinational logic gates, a programmable gate array(s) (PGA), a field-programmable gate array (FPGA), etc.

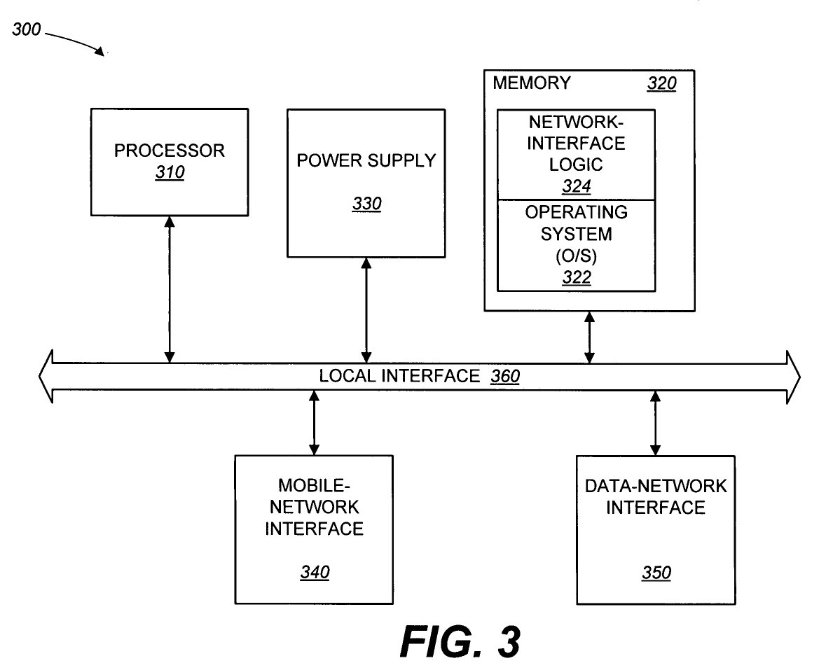

FIG. 3 is a block diagram illustrating an embodiment of the mobile-network bridge 300 of FIG. 1. Generally, in terms of hardware architecture, as shown in FIG. 3, mobile-network bridge 300 includes processor 310, memory 320, power supply 330, mobile-network interface 340 and data-network interface 350. Processor 310, memory 320, mobile-network interface 340 and data-network interface 350 are communicatively coupled via a local interface 360. The local interface 360 can be, for example but not limited to, one or more buses or other wired or wireless connections, as is known in the art. The local interface 360 may have additional elements, which are omitted for simplicity, such as controllers, buffers (caches), drivers, repeaters, and receivers, to enable communications. Further, the local interface 360 may include address, control, and/or data connections to enable appropriate communications among the aforementioned components.

Power supply 330 provides power to each of the processor 310, memory 320, mobile-network interface 340, data-network interface 350 and local interface 360 in a manner understood by one of ordinary skill in the art.

Processor 310 is a hardware device for executing software, particularly that stored in memory 320. The processor 310 can be any custom made or commercially available processor, a CPU, an auxiliary processor among several processors associated with the mobile-network bridge 300, a semiconductor based microprocessor (in the form of a microchip or chip set), or generally any device for executing software instructions.

The memory 320 can include any one or combination of volatile memory elements (e.g., RAM, such as DRAM, SRAM, SDRAM, etc.) and nonvolatile memory elements (e.g., ROM, hard drive, tape, CDROM, etc.). Moreover, the memory 320 may incorporate electronic, magnetic, optical, and/or other types of storage media. Note that the memory 320 can have a distributed architecture, where various components are situated remote from one another, but can be accessed by the processor 310.

The software in memory 320 may include one or more separate programs, each of which comprises an ordered listing of executable instructions for implementing logical functions. In the example of FIG. 3, the software in the memory 320 includes operating system 322 and network-interface logic 324. The operating system 322 essentially controls the execution of other computer programs, such as network-interface logic 324 and provides scheduling, input-output control, file and data management, memory management, and communication control and related services.

Network-interface logic 324 comprises one or more programs and one or more data elements that enable the mobile-network bridge 300 to receive and forward communication streams between mobile network 120 via connection 114 and data network 130 via connection 132. In this regard, network-interface logic 324 may include one or buffers and parameter stores for holding configuration information and or data as may be required. Network-interface logic 324 is a source program, executable program (object code), script, or any other entity comprising a set of instructions to be performed. When implemented as a source program, the program is translated via a compiler, assembler, interpreter, or the like, which may or may not be included within the memory 320, so as to operate properly in connection with the O/S 322. Furthermore, network-interface logic 324 can be written in one or more object oriented programming languages, which have classes of data and methods, or procedure programming languages, which has routines, subroutines, and/or functions. In the currently contemplated best mode, network-interface logic 324 is implemented in software, as an executable program executed by processor 310.

Mobile-network interface 340 enables mobile-network bridge 300 to communicate with various devices over a mobile network such as cellular services network 120 (FIG. 1) via connection 114. The mobile-network interface 340 performs a variety of functions including, for example: answering a phone line; hanging-up a phone line; dialing a phone number; sending data signals; receiving data signals; generating DTMF tones; detecting DTMF tones; receiving automatic-number identification—the number from which a caller initiates a call (AND, DNIS; and playing voice messages.

Data-network interface 350 enables mobile-network bridge 300 to communicate with various devices over the data network 130 (FIG. 1) via connection 132. The data-network interface 350 performs the signal conditioning and format conversions to communicate data through the data-network interface 130. An example data-network interface 350 is compatible with the 100Base T Ethernet standard and the TCP/IP protocol. It should be understood that other data-network interfaces including, for example and without limitation, wired and wireless data-network interfaces, analog-data network interfaces, digital data-network interfaces, optical data-network interfaces, and data-network interfaces compatible with other hardware and software standards and protocols may also be used.

When mobile-network bridge 300 is in operation, the processor 310 is configured to execute software stored within the memory 320, to communicate data to and from the memory 320, and to generally control operations of the mobile-network bridge 300 pursuant to the software. The network-interface logic 324 and the O/S 322, in whole or in part, but typically the latter, are read by the processor 310, perhaps buffered within the processor 310, and then executed.

When the network-interface logic 324 is implemented in software, as is shown in FIG. 3, it should be noted that the network-interface logic 324 can be stored on any computer-readable medium for use by or in connection with any computer related system or method. In an alternative embodiment, where the network-interface logic 324 is implemented in hardware, the network-interface logic 324 can be implemented with any or a combination of the following technologies, which are each well known in the art: a discrete logic circuit(s) having logic gates for implementing logic functions upon data signals, an ASIC having appropriate combinational logic gates, a PGA, a FPGA, etc.

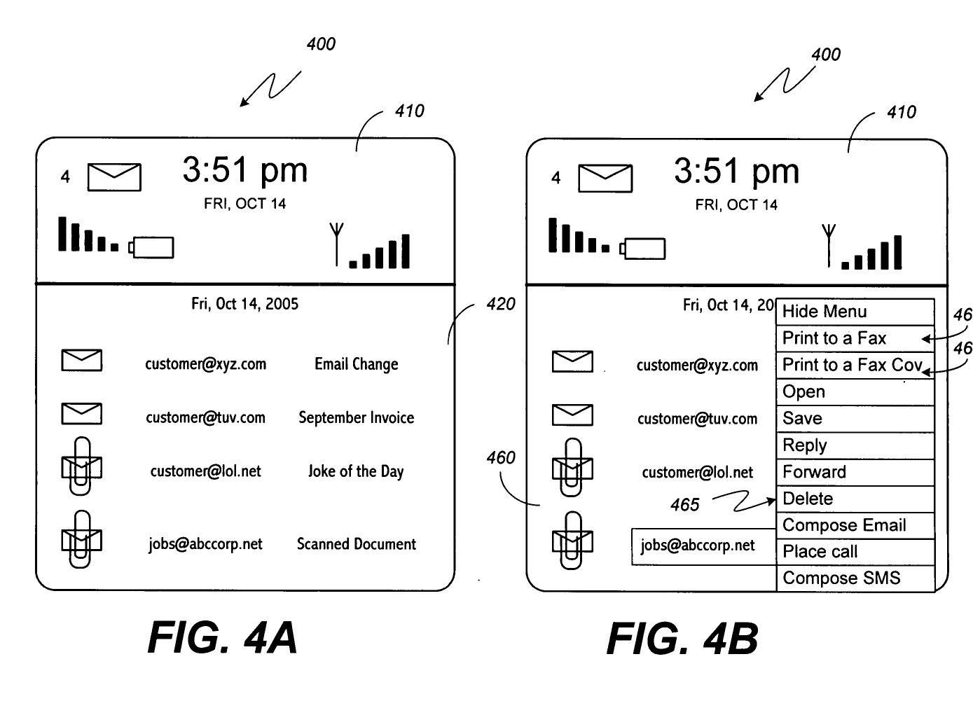

FIGS. 4A and 4B are schematic diagrams illustrating embodiments of a graphical-user interface on the mobile-communication device 110 of FIG. 1. As illustrated in FIG. 4A, graphical-user interface 400 comprises a header 410 and frame 420. Header 410 comprises information that is consistently updated and displayed while mobile-communication device 110 is activated and functioning in a message handling mode of operation. Header 410 comprises time, day and date information as well as a message storage field that shows how many new messages have been received and stored on mobile-communication device 110. Header 410 also includes battery and signal indicators, which provide a visual indication of battery and received signal strength.

Frame 420 presents a tabular list that includes information about each of the new messages stored on mobile-communication device 110. Each row in the tabular list presents information concerning a respective new message on the mobile-communication device 110. In the example embodiment, frame 420 shows that each of the four messages was received on Friday, Oct. 14, 2005. The tabular list includes a first row showing a message from customer@xyz.com with a subject titled, “Email change;” a second row showing a message from customer@tuv.com is titled, “September Invoice;” a third row shows a message from customer@lol.net, which is titled, “Joke of the Day;” and a fourth row shows a message from jobs@abccorp.net, titled, “Scanned Document.” The icons in the left most column indicate that the first two messages do not include attachments and that the last two messages include one or more attachments.

FIG. 4B illustrates graphical-user interface 400 after an operator of mobile-communication device 110 has used a pointing device to highlight the last of the four new messages and entered a “select item” input. Frame 460 shows the last of the four messages in a highlighted state and includes pop-up menu 465. Pop-up menu 465 includes a host of options for managing the menu, processing the highlighted message and any attachments, placing a call, composing a new e-mail message, composing a short-message system (SMS) or text message among others. Menu option 466, labeled “Print to a Fax” and menu option 468, labeled, “Print to a Fax Cover Sheet” open separate interfaces for collecting information from an operator of mobile-communication device 110.

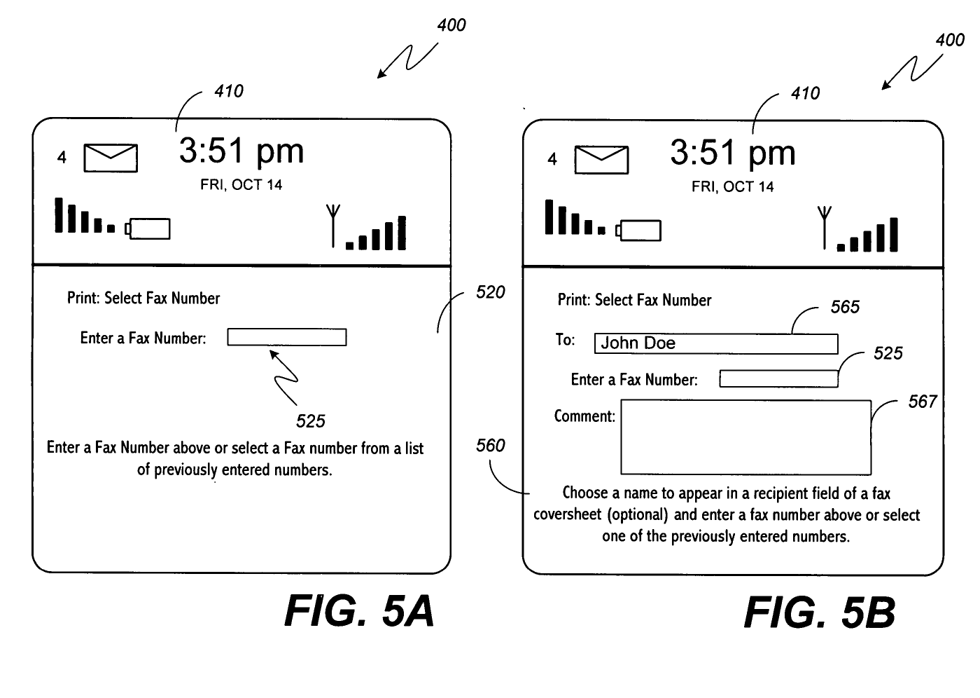

FIG. 5A illustrates graphical-user interface 400 after an operator of mobile-communication device 110 has selected menu option 466. Frame 520 shows that the device is preparing to print the attachment to a select fax device. Frame 520 includes field 520 for an operator of mobile-communication device 110 to enter a facsimile number. If the operator desires to select a facsimile number from a list of previously entered numbers, the operator may simply enter the select input on the mobile-communication device 110 to open a menu that includes an option to view a list of previously entered facsimile numbers and an option to enter the user's address book to select a facsimile number (not shown).

FIG. 5B illustrates graphical-user interface 400 after an operator of mobile-communication device 110 has selected menu option 468. Frame 560 shows that the device is preparing to print the attachment to a select fax device. Frame 560 includes field 565 for an operator of mobile-communication device 110 to enter a recipient's name, field 525 for entering a facsimile number, and field 567 for entering a comment or brief message to the recipient of the facsimile. The information entered within frame 560 is used by fax server 200 to generate a fax cover sheet. If the operator desires to select a facsimile number from a list of previously entered numbers, the operator may simply enter the select input on the mobile-communication device 110 to open a menu that includes an option to view a list of previously entered facsimile numbers and an option to enter the user's address book to select a recipient name and a destination facsimile number (not shown).

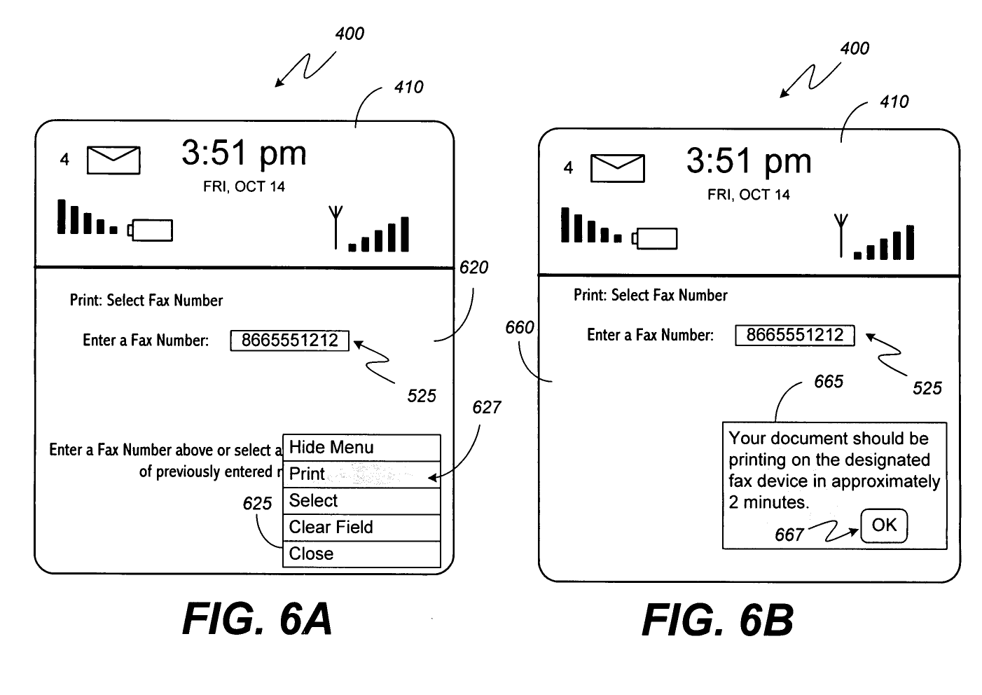

FIG. 6A illustrates graphical-user interface 400 after an operator of mobile-communication device 110 has selected menu option 466, entered a destination facsimile number and entered a select input on mobile-communication device 110. Frame 620 includes the completed field 525 with a destination fax number and pop-up menu 625. Pop-up menu 625 includes options for managing the menu and printing the attachment. It should be understood that a destination facsimile device may be identified by alternative identifiers in addition to a telephone number. For example, a name, or a phrase describing the location, an owner, etc. can be associated with the destination number. The association could be enabled on the mobile-communication 4 device 110 or on fax server 200.

When an operator of mobile-communication device 110 selects option 627, labeled, “print,” the mobile-communication device 110 composes and forwards an e-mail message to fax server 200. The e-mail message includes the facsimile destination number and information identifying the attachment. The e-mail message directs the fax server to locate the attachment, convert the attachment from its native format into an image file format and transmit the image file format representation of the attachment via PTN 140 to the select fax device.

FIG. 6B illustrates graphical-user interface 400 after an operator of mobile-communication device 110 has selected menu option 627. Frame 660 includes field 525 and message field 665. In preferred embodiments, message field 665 is presented after fax server 200 has located the attachment and confirmed that it has access to an appropriate conversion engine for translating the attachment from its native file format to an image file format compatible with facsimile transmissions over PTN 140. Frame 660 further includes pushbutton 667, which when highlighted and selected by an operator returns the operator to the message interface illustrated in FIG. 4A.

While the graphical-user interfaces presented in FIGS. 4A, 4B, 5A, 5B, 6A and 6B show specific embodiments of frames, menu options, fields, etc., it will be appreciated that any number of fields, menus, options, or messages might be added to the interfaces described herein, for purposes of enhanced utility, accounting, troubleshooting, etc. All such variations are within the scope of the present systems and methods for providing a remote print capability to a mobile-communication device.

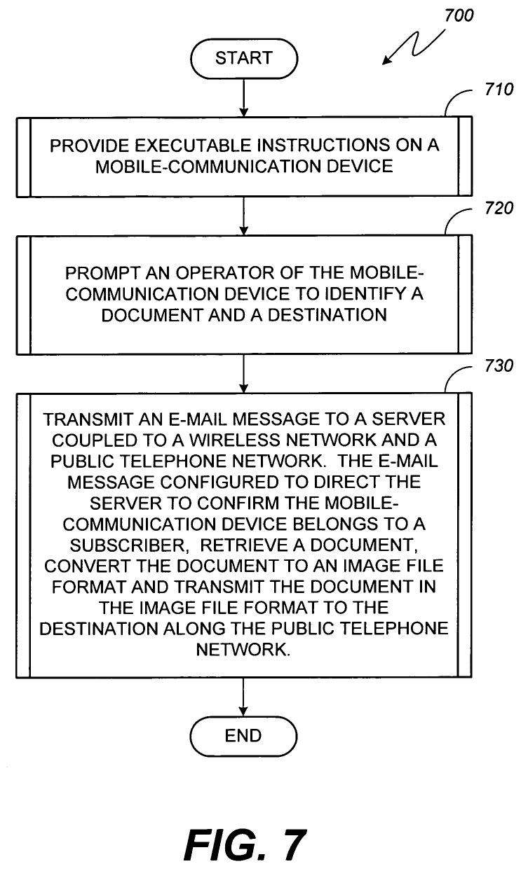

FIG. 7 is a flow diagram illustrating an embodiment of a method for providing a remote print capability. The flow diagram of FIG. 7 shows the architecture, functionality, and operation of a possible implementation via software and or firmware associated with communicatively coupled hardware devices that enable an operator of a mobile-communication device to identify a document and direct a remote fax server to convert and transmit the identified document to a designated facsimile device. In this regard, each block represents a module, segment, or portion of code, which comprises one or more executable instructions for implementing the specified function(s). Method 700 begins with block 710 where a service provider installs executable instructions on a mobile-communication device 110. In some embodiments, the mobile-communication device 110 is a cellular telephone and the service provider is the provider of cellular phone service. Typically, the service provider installs or otherwise provides a Java application on the mobile-communication device 110.

When operable, the mobile-communication device 110, via the Java application, responds to one or more operator inputs via a control interface and as indicated in block 720, prompts the operator to identify a document and a destination. Thereafter, as illustrated in block 730, the mobile-communication device 110 transmits an e-mail message to a server via a wireless network. The e-mail message contains information that directs the server to confirm the mobile-communication device 110 belongs to a subscriber of the mobile print-to-fax service. The server further retrieves the document, converts the document to an image file format and transmits the document in the image file format to the destination along the public telephone network.

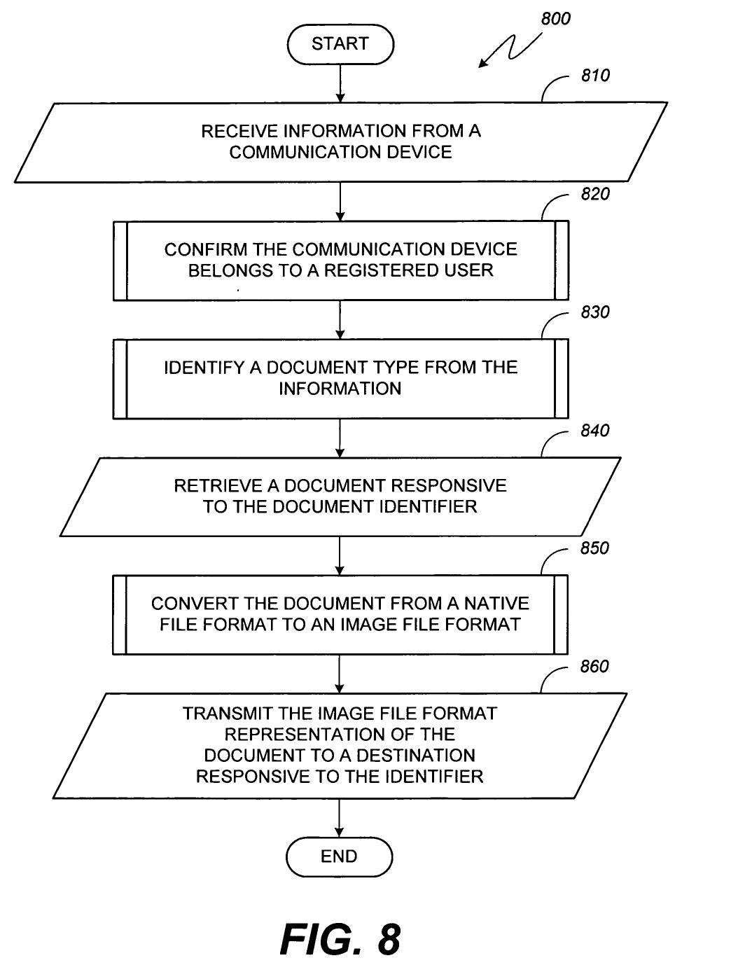

FIG. 8 is a flow diagram illustrating an embodiment of an alternative method for providing a remote print capability. The flow diagram of FIG. 8 shows the architecture, functionality, and operation of a possible implementation via software and or firmware associated with a server configured to enable an operator of a communicatively coupled mobile-communication device 110 to print a document using a designated facsimile device. In this regard, each block represents a module, segment, or portion of code, which comprises one or more executable instructions for implementing the specified function(s). Method 800 begins with block 810 where a fax server receives information from a communication device. In block 820, the fax server confirms the communication device belongs to a registered user. When the communication device is a mobile telephone that uses the global standard for mobile communications (GSM), a security identity module that contains information used to identify subscribers and their account information to the GSM network can be used to confirm the communication device belongs to a subscriber to a mobile print-to-facsimile device service.

In block 830, the fax server identifies a document type from the information provided by the communication device. When the information is in the form of an email message with an attachment, the attachment will generally include a filename and path defining where the file can be found. Next, in block 840, the fax server retrieves the document defined by the document identifier. The filename of the attachment will generally include an extension that identifies an originating application that can be used to interpret the file. For example, documents generated with a word processor application typically are given a filename that includes an extension “.doc.” Image files are generally identified with the extension “.pdf.” Other files, such as those generated and saved using a popular spreadsheet application have an extension of “.xls.” These and other extensions can be used to identify an appropriate converter for interpreting the file and generating an image file format representation of a select document. Thereafter, as indicated in block 850, the fax server converts the defined document from its native file format to an image file format compatible with facsimile communications. In block 860, the fax server transmits the image file format representation of the document to a destination identified by the destination identifier. When the destination device is a standalone device such as a facsimile machine or a multi-function machine the destination identifier will be a telephone number designated for facsimile communications. When the destination device is a printer or a multi-function machine coupled to a computing device, the telephone number may be associated with both voice-band and broadband services.

The systems and methods providing a remote print capability to a mobile-communication device may be embodied in software or code executed by general purpose hardware as discussed above, or may be embodied in dedicated hardware or a combination of software/general purpose hardware and dedicated hardware. If embodied in hardware, the method for providing a remote print capability may be expressed or implemented as a circuit or state machine that employs any one of or a combination of a number of technologies. These technologies may include, but are not limited to, discrete logic circuits having logic gates for implementing various logic functions upon an application of one or more data signals, ASICs having appropriate logic gates, PGAs, FPGAs, or other components. Such technologies are generally well known by those of ordinary skill in the art.

As described above, the flow diagrams of FIGS. 7 and 8 show the architecture, functionality and operation of an implementation of various methods for providing a remote print capability to a mobile-communication device. The program instructions may be embodied in source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

While the flow diagrams of FIGS. 7 and 8 show a specific order of execution, it will be appreciated that two or more steps in the diagrams that are shown executed in succession may be executed concurrently or with partial concurrence. In addition, any number of counters, state variables, warning semaphores, or messages might be added to the logical flow described herein, for purposes of enhanced utility, accounting, performance measurement, troubleshooting, etc. All such variations are within the scope of the present systems and methods for providing a remote print capability to a mobile-communication device. The flow diagrams of FIGS. 7 and 8 may be used by one of ordinary skill in the art to create software and/or hardware to carry out the various logical functions described and illustrated.

While various embodiments of the systems and methods for mobile-communication device directed printing have been described, it will be apparent to those of ordinary skill in the art that many more embodiments and implementations are possible that are within the scope of the accompanying claims. Accordingly, the systems and methods for mobile-communication device directed printing are not to be restricted beyond the attached claims and their equivalents.

What is claimed is:

1. A method for providing a remote print capability, the method comprising:
receiving information from a communication device, the information comprising document and destination identifiers;
confirming the communication device belongs to a registered user;
identifying a document type from the information;
retrieving a document responsive to the document identifier;
converting the document from a native format to an image file format; and
transmitting the image file format representation of the document to a destination responsive to the destination identifier.

2. The method of claim 1, wherein receiving information comprises receiving an electronic mail message.

3. The method of claim 2, wherein receiving information comprises receiving an attachment field.

4. The method of claim 1, wherein receiving information comprises receiving a name.

5. The method of claim 1, wherein receiving information comprises receiving a comment.

6. The method of claim 1, wherein receiving information comprises receiving a facsimile destination number.

7. The method of claim 1, further comprising:
generating an image file format representation responsive to one or more of a name, the destination identifier, a subject and a comment and sending the image file format representation with the document.

8. The method of claim 1, wherein the destination identifier comprises a telephone number.

9. The method of claim 1, wherein the destination is a facsimile device.

10. A method for providing a remote print capability, the method comprising:
providing executable instructions on a mobile-communication device, such that when executed by the mobile-communication device, the device:
prompts an operator of the mobile-communication device to identify a document and a destination; and
transmits an electronic mail message to a server coupled to a wireless network and a public telephone network, the electronic mail message configured to direct the server to confirm the mobile-communication device belongs to a subscriber, retrieve a document, convert the document to an image file format and transmit the document in the image file format to the destination along the public telephone network.

11. The method of claim 10, wherein providing executable instructions on a mobile-communication device comprises storing a Java application on the mobile-communication device.

12. The method of claim 10, wherein providing executable instructions on a mobile-communication device comprises integrating information available from an address book.

13. The method of claim 10, wherein the operator of the mobile-communication device is further prompted to enter a comment.

14. The method of claim 10, wherein the mobile-communication device receives a confirmation notice.

15. The method of claim 14, wherein the confirmation notice is responsive to a status indicator communicated to the server from the destination.

16. A system, comprising:
a processor;
a first interface in communication with the processor and a public-telephone network;
a second interface in communication with the processor and a data network, the data network further coupled to a wireless-communication device; and
a memory in communication with the processor, the memory comprising executable instructions that when executed by the processor direct the system to receive information via the second interface from a mobile-communication device, the information comprising a document identifier and a destination identifier, convert a document responsive to the document identifier from a native file format to an image file format representation of the document and transmit the image file format representation of the document via the first interface to a destination responsive to the destination identifier.

17. The system of claim 16, wherein the memory further comprises executable instructions that when executed by the processor direct the system to confirm the mobile-communication device belongs to a registered user.

18. The system of claim 16, wherein the memory further comprises executable instructions that when executed by the processor direct the system to retrieve a document responsive to the document identifier.

19. The system of claim 16, wherein the memory further comprises executable instructions that when executed by the processor direct the system to receive information entered by an operator of the mobile-communication device.

20. The system of claim 16, wherein the memory further comprises executable instructions that when executed by the processor direct the system to generate an image file format representation responsive to one or more of a name, the destination identifier, a subject and a comment and integrate the image file format representation with the document.
